(19) United States
(12) Patent Application Publication
(10) Pub. No.: US 2004/0197435 A1
(43) Pub. Date: Oct. 7, 2004

(54) Device to produce a multi-colored injection molded, extruded or blow molded article

(76) Inventors: Dan Shepherd, Upper Sandusky, OH (US); Susan K. Shepherd, Upper Sandusky, OH (US); Lloyd Swavel, Upper Sandusky, OH (US)

Correspondence Address: JERRY SEMER, 617 CROGHAN ST., FREMONT, OH, 43420, US

(21) Appl. No.: 10/753,987

(22) Filed: Jan. 8, 2004

Related U.S. Application Data
(60) Provisional application No. 60/438,958, filed on Jan. 9, 2003.

(51) Int. Cl. B29B 15/00

(52) U.S. Cl. 425/449

(57) ABSTRACT

The invention is basically a device that injects colors into the plastic at the nozzle end of the injection screw. To place the invention on an injection screw, one drills a small opening in the injector barrel just before the injection nozzle. One then attaches a check valve to this opening. To the check valve, a color tube, a flow control valve, and a color pump are attached. Attached to the color pump are the color hopper with liquid color pigment and the high-pressure air supply line. The high-pressure air runs the color pump and pumps the color pigment under pressure into the flow control valve, the color line, the check valve and the barrel. For each color that an individual wishes to add to the plastic, one uses a separate opening, check valve, tube, flow control valve, and color hopper.

### BACKGROUND OF THE INVENTION

In the usual injection, blow-molding or extrusion process, plastic granules are placed in a hopper. The coloring is added to the hopper. The plastic granules and colorant mixture are mixed in the hopper. This plastic and coloring mixture comes out of the bottom of the hopper and is heated to a temperature that liquefies or semi-liquefies the plastic. Plastic then moves into a screw type device that not only mixes the plastic and the coloring together, but also puts the plastic and the coloring under pressure for injection and into the mold. The plastic is mixed with the colorant before it is injected into the mold.

There is no way in the prior art known to the inventor to produce more than one color with the plastic injected into the mold. Even if two colors were placed with the plastic capsules in the hopper, these two colors would be thoroughly mixed and come out as a color which is a mixture of the two colors rather than two separate colors. The injecting cylinder with pressurizes the plastic for injection in to the mold also thoroughly mixes the plastic with the color.

Thus, one of the objectives of this invention is to produce a method to create an injection molded, blow molded or extruded product which has visible multi-colors on it.

Another objective of this invention is to create a device that can be added to an existing injection mold machine and enable the operator to produce a multicolored product. Further objectives are to make this device inexpensive and easy to manufacture. The device also must be easy to place upon the machine.

The feature that accomplishes this is that the inventor has been able to inject the colorant into the plastic at the end of the injection cylinder and thus the color does not become thoroughly mixed with the plastic.

U.S. Pat. No. 4,247,501 to Easley et al. and U.S. Pat. No. 4,125,582 to Langlois describe system similar to each other for producing multicolored injection molded parts. These systems do not show any method or device to control where the color will be placed on the molded object, or the spacing of the marbleized rings on the molded object.

### SUMMARY OF THE INVENTION

The invention is basically a device that injects colors into the plastic at the nozzle end of the injection screw, thus the colors do not become thoroughly mixed together before the colors and the plastic are injected in to the blow or injection mold or extruded. To place the invention on an injection mold machine, a blow mold machine or an extrusion machine, one drills a small opening in the injector barrel near the end of the injection barrel just before the injection nozzle which injects the plastic in to the blow or injection mold or extruder. At this point the plastic is under high pressure and temperature. One then attaches a check valve to this opening. To the check valve, a color tube is attached. At the other end of the color tube a flow control valve is attached. Attached to the flow control valve is the color pump. Attached to the color pump are the color hopper and the high-pressure air supply line. The color hopper contains liquid color pigment. The high-pressure air supply line delivers high-pressure air to the color pump. The high-pressure air runs the color pump and pumps the color pigment under pressure into the flow control valve. The flow control valve controls the volume of liquid colorant that flows into the color line, the check valve and the barrel of the injection mold, blow mold, or extrusion machine. The color pigment is pumped at a higher pressure than the plastic within the barrel and thus, the color pigment moves into the barrel and into the plastic. In this embodiment the color is pressurized by high pressure air supply. However, it could be pressurized by other means known in the art such as hydraulics. The check valve is placed on the injection cylinder to ensure that none of the plastic backs up into the invention. For each color that an individual wishes to add to the plastic one uses a separate opening, check valve, tube, flow control valve, and color hopper. Each of these is attached to a high pressure air or hydraulics.

### BRIEF DESCRIPTION OF THE DRAWINGS

FIG. 1 is a drawing of the invention.

FIG. 2 is a drawing of the invention attached to the barrel of a injection, blow mold or extrusion machine.

FIG. 3 is a drawing of another embodiment of the invention attached to the barrel of an injection, blow mold or extrusion machine.

### DETAILED DESCRIPTION OF THE PREFERRED EMBODIMENT

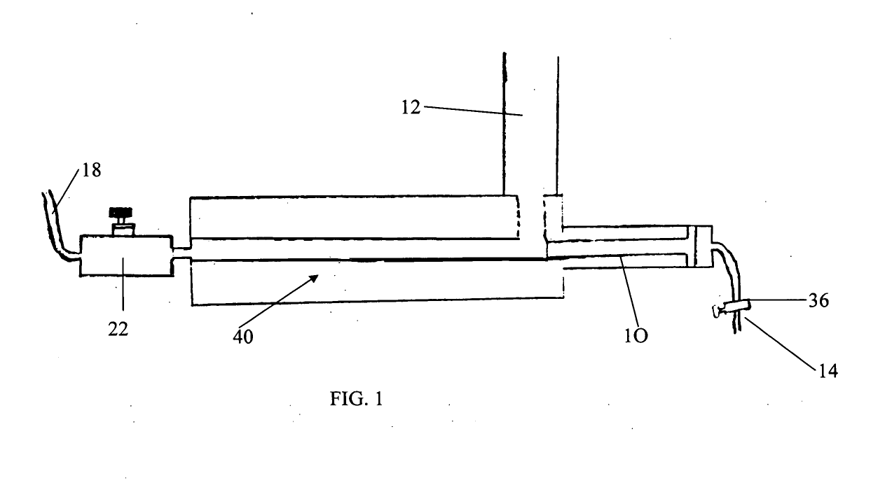

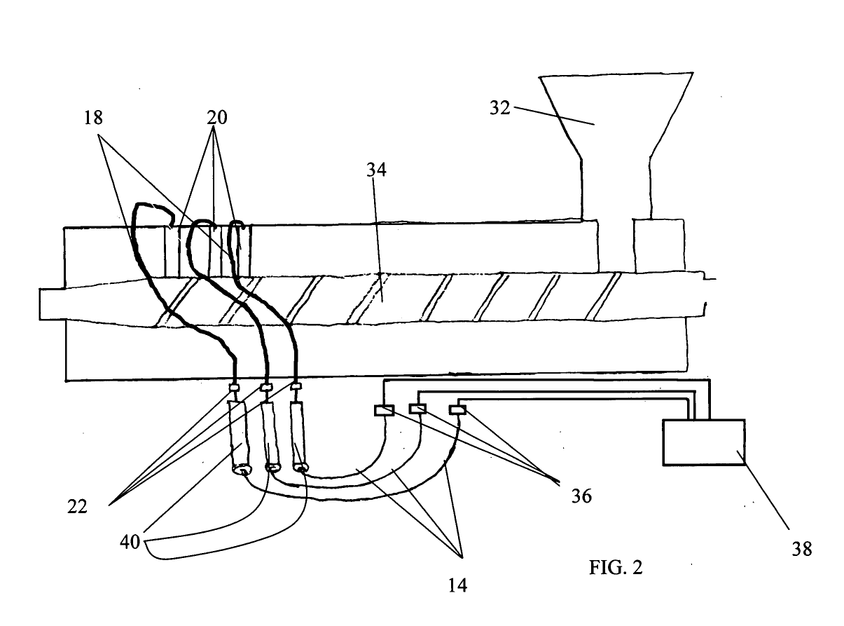

FIG. 1 shows the liquid color injection unit 40 of the invention. FIG. 1 shows the color pump 10 which has the color hopper 12 and a high pressure air supply line 14 attached to it. In the preferred embodiment air is used to run the color pump 10 however hydraulics or electricity as well as other methods known in the art could also be used to run the pump. The pigment of the color which you wish to add to the plastic is poured into the color hopper 12. The pigment used to make the color is a liquid pigment. The color pigment flows from the color hopper 12 in to the color pump 10 and is mixed with the high-pressure air from the high-pressure air supply line 14. The high-pressure supply airline 14 brings in air at approximately 120 pounds of pressure. This is approximately the pressure needed to inject the color in to the barrel 30 of an injection mold, blow mold or extrusion machine as shown in FIG. 2. Once the color is pressurized by the air supply, the color moves through flow control valve 22 and into color line 18 to a check valve 20 which is attached to the barrel 30 as shown in FIG. 2. This check valve 20 is designed to keep the plastic in the barrel 30 from back flowing into the color line 18 and the flow control valve 22. This check valve 20 needs to be placed in the barrel or very close to the point at which the color is injected into the barrel or the plastic will back up and clog the machine.

FIG. 2 shows the injection barrel 30, plastic hopper 32 and screw 34 of an injection mold, blow mold, or extrusion machine. with three liquid colorant injection unites 40 of FIG. 1 attached to it. In this embodiment, three different colors can be added to the plastic to be molded. It is not necessary to use all three colors or one could actually add more devices to add more colors. FIG. 2 shows the barrel 30. On the barrel 30 each of the three lines 18 and check valves 20 of the three liquid colorant injection unites 40 are attached. The check valves 20 are attached by drilling small openings into the barrel 30. This opening is place near the injector end of the barrel so that the color pigment will not thoroughly mix with the plastic. The opening however must be place in the barrel 30 and not in the injector. The check valves 20 are then attached to the barrel 30 at these openings. In the preferred embodiment the openings are thread and the check valves 20 are thread and the check valves 20 screw into the openings. These openings extends into the barrel 30 far enough that when the color pigment from the color hoppers 12 flows through color pumps 10 to the flow control valves 22 and into the color lines 18 and through the check values 20, the pigment mixes with the plastic within the barrel 30. After the check valves 20 have been threaded into the barrel 30, the color lines 18 is attached to the check valve 20 as shown in FIG. 2. Attached to the color lines 18 are the flow control valves 22. As shown in FIG. 1 attach to the flow control valve 22 is the color pump 10 with the color hopper 12 containing the color pigment and the high-pressure supply line 14. The color pigment form the color hopper 12 flows in color pump 10 and is pressurized with the high-pressure air from the high-pressure air supply 14. On the flow control valve 22 is a color control switch, which control the flow of the color pigment from the color hopper 12 through the flow control valve 22 and ultimately into the barrel 30.

To use the device, the device is attached to the barrel 30 as explained in the previous paragraph and shown in FIG. 2. Color pigment is placed in to the color hopper 12. Next, the high pressure air supply 38 is switch on by air solenoid 36 sending high pressure air through the high pressure air line 14. The high-pressure air runs the color pump 10 and pumps the color pigment into the flow control valve 22 to the color line 18. The flow control value 22 controls the flow rate of color pigment into the color line 18. From the color line 18 the color pigment flows into the check valve 20 and into the barrel 30 where it mixes with the plastic to be molded. In the preferred embodiment, the air supply can deliver up to one hundred twenty pounds of pressure. This is the approximate amount of pressure needed to inject the color in to the plastic at the end of the barrel 30. Within the barrel 30 is a screw 34 that mixes the plastic and places it under high pressure for injection into an injection mold or blow mold or extrusion. Thus, the color pigment must be forced in to the injection cylinder 30 under high pressure.

The color injected by the above-described method creates a marbleized pattern in the final product. If you put in more than one color, you will have differing rings or strips of marbleization. By this method, the coloring pattern of the final product cannot be exactly predicted; however, the amount in which one color bleeds into another or the distance between colors can be somewhat controlled. This can be done by controlling the output of the color pump 10 and the output of the flow control valve 22. The color pump 10 does not pump in an even flow of color but pumps the color in a set of bursts. By controlling the timing of these bursts, one can control the amount each marbleized ring bleeds into the one next to it or the distance between them. The timing of these burst is controlled by turning on and off the air supply by switching on and off the air solenoids 36. One can also control the order of the colors in the final product. Since each color has a different color pump by controlling the sequence in which the pumps fires one can also control the sequence of the colors of the molded object.

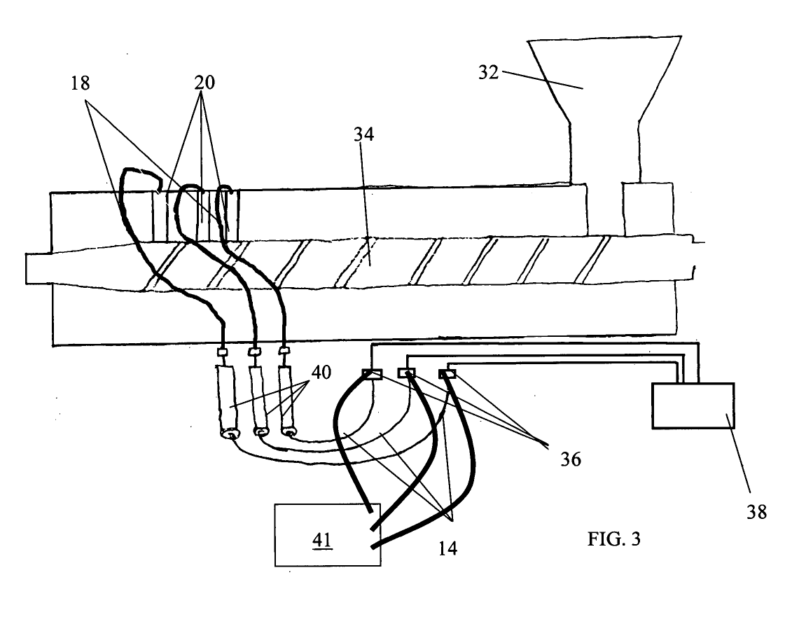

The embodiment that achieves the control of the placement of the color on molded object is shown in FIG. 3. This embodiment uses three different colors. All three color pumps 10 are controlled by a micro processor 41 which turns on and off the air solenoids 36 for each color pump. The bursts from each of the color pumps 10, in this embodiment, could occur simultaneous or at different times according to the pattern one wishes to produce. The microprocessor 41 would be preprogrammed to produce the specific pattern. Everything is the same in this embodiment as shown in FIG. 3 as the previous embodiment shown in FIG. 2, except that the microprocessor 41 controls the output of each of the color pumps 10 by turning on an off the air solenoid 36 for each color pump 10. As shown in FIG. 3 to use the three liquid colorant injection unites 40 one attaches the three liquid colorant injection unites 40 to the barrel 30 as explained in previous paragraphs. Three color pigments are placed each in their color hopper 12. Next, the microprocessor 41 is switched on and it take over the control of the three liquid colorant injection unites 40. The microprocessor switches on and off the three liquid colorant injection unites' 40 by switching on and off the air solenoid 36 according to a given pattern which was chosen by the operator. The high-pressure air supply 38 sends high-pressure air through the high-pressure airline 14 to all three color pumps 10. The switching on and off of air solenoid 35 controls the rate and the timing of the color pigment output of the color pumps 10. As I stated above, the color pumps 10 pumps in short bursts. All three air solenoids are attached to the microprocessor 41, which is able to control the solenoid and the pumping of all three color pumps 10. A program has been placed in the microprocessor 41 that controls the timing of all three color pumps 10. Each color pump 10 controlled by the microprocessor 41, pumps each color pigment into each of the flow control valve 22 and each of the color lines 18. The different pigment in each color line 18 flows into each of the check valves 20 and into the barrel 30. The plastic then will be injected into the mold producing the desired pattern.

I claim

1. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion comprising:
a. a power supply; and,
b. a first container for holding color pigment with two opening which allows color to be added to the first container and allows color pigment to flow out of the first container; and
c. a first means for pumping color pigment that is driven by energy from the power supply; and,
d. a first switch that controls the flow of energy from the power supply to the first means for pumping color pigment; and,
e. a means to control the flow of color pigment from all means for pumping color pigment
f. a first tube that direct the flow of color pigment from the first means for pumping color pigment to the end of the barrel of the injection mold, blow mold, or extrusion machine; and
g. a first opening in the barrel that allows the color to flow into the barrel to which the first tube is attached;
h. a first means to insure that the plastic in the barrel will not flow into the first tube; and
i. whereas color pigment is added to the first container and the first pumping means pumps the color pigment into the first tube through which the color pigment moves to the first opening in the barrel where the color pigment flows into the barrel.

2. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 1 further comprising:
a. a first means for controlling the flow of color pigment through the first tube attached to the first tube.

3. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 1 whereas:
a. the first means to insure that the plastic in the barrel will not flow into the first tube is a first check valve placed in the first opening in the barrel.

4. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 1 wherein:
a. the means to control the flow of color pigment from the all means for pumping color pigment is a microprocessor that controls the flow to energy from the power supply to all means for pumping color pigment.

5. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 4 wherein:
a. the power supply is a high pressure air supply attached to all means for pumping color pigment.

6. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 4 wherein:
a. the power supply is a high pressure air supply and a first line to carry the high pressure air to the first means for pumping color pigment.

7. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 6 wherein:
a. the first switch is a first solenoid for turning off and on the flow of air from the air supply to the first means for pumping color pigment.

8. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 4 whereas:
a. the means to control the flow of color pigment from the all means for pumping color pigment in respect to the first means for pumping color pigment is the microprocessor that controls the flow to energy from the power supply to the first means for pumping color pigment by controlling the first switch's control of the energy from the power supply delivered to the first means for pumping color pigment.

9. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 5 further comprising:
a. a first means for controlling the flow of color pigment through the first tube attached to the first tube.

10. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 8 further comprising:
a. a first means for controlling the flow of color pigment through the first tube attached to the first tube.

11. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 5 wherein:
a. the means to insure that the plastic in the barrel will not flow into the tube is a check valve attach between the tube and the opening in the barrel.

12. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 8 wherein:
a. the means to insure that the plastic in the barrel will not flow into the tube is a check valve attach between the tube and the opening in the barrel.

13. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 9 wherein:
a. the means to insure that the plastic in the barrel will not flow into the tube is a check valve attach between the tube and the opening in the barrel.

14. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 10 wherein:
a. the means to insure that the plastic in the barrel will not flow into the tube is a check valve attach between the tube and the opening in the barrel.

15. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 1 further comprises:
a. a second container for holding color pigment with two opening which allows color to be added to the second container and allows color pigment to flow out of the second container; and
b. a second means for pumping color pigment that is driven by energy from the power supply; and,
c. a second switch that controls the flow of energy from the power supply to the second means for pumping color pigment; and,
d. a second tube that direct the flow of color pigment from the second pumping means to the end of the barrel of the injection mold, blow mold, or extrusion machine; and
e. a second opening in the barrel that allows the color to flow into the barrel to which the first tube is attached;
f. a second means to insure that the plastic in the barrel will not flow into the tube; and
g. whereas color pigment is added to the second container and the second means for pumping the color pigment pumps the color pigment into the second tube through which the color pigment moves to the second opening in the barrel where the color pigment flows into the barrel.

16. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 1 wherein:
a. the means to control the flow of color pigment from the all means for pumping color pigment is a microprocessor that controls the flow to energy from the power supply to all means for pumping color pigment.

17. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 4 wherein:
a. the power supply is a high pressure air supply attached to all means for pumping color pigment.

18. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 6 wherein:
a. the second switch is a solenoid for turning off and on the flow of air from the air supply to the second means for pumping color pigment.

19. A device for producing a multi colored object by injection molding, blow molding, or extrusion machine and said machine has a barrel which contains plastic for injecting in injection or blow molds or extrusion and where the plastic to be injected into the blow or injection mold or extruded is mixed and pressurized and said barrel has an end from which the plastic is injected into a blow or injection mold or extrusion as in claim 4 whereas:
a. the means to control the flow of color pigment from the all means for pumping color pigment in respect to the second means for pumping color pigment is the microprocessor that controls the flow to energy from the power supply to the second means for pumping color pigment by controlling the second switch's control of the energy from the power supply delivered to the second means for pumping color pigment.
